(19) United States
(12) Patent Application Publication
(10) Pub. No.: US 2016/0199856 A1
(43) Pub. Date: Jul. 14, 2016

(54) Variable Flow Nozzle System and Method

(71) Applicant: Pentair Flow Technologies, LLC, Delavan, WI (US)

(72) Inventors: Veena Raghunandan, Noida (IN); Arminder Singh, Fazilka (IN); Simon Waddelow, Ely (GB)

(21) Appl. No.: 14/993,723

(22) Filed: Jan. 12, 2016

Related U.S. Application Data
(60) Provisional application No. 62/102,444, filed on Jan. 12, 2015.

(51) Int. Cl. B05B 1/30

(52) U.S. Cl. CPC B05B 1/3006; B05B 1/3013

(57) ABSTRACT

Embodiments of the invention provide a variable flow nozzle assembly capable of flowing a fluid within a range of flow rates in response to a variable upstream pressure. A spray tip defines a chamber and a flow port in communication with the chamber. A pre-orifice defines a flow path in communication with the chamber and a metering portion along the flow path. A spool valve defines a spool rod portion positioned within the metering portion and configured to be moveable in response to an applied upstream fluid pressure between a minimum and a maximum flow position. A biasing mechanism biases the spool valve toward the minimum flow position. An opening between the metering and spool rod portions allows for fluid flow through the flow path to be greater when the spool valve is in the maximum flow position than when in the minimum flow position.

### RELATED APPLICATION

This application claims priority under 35 U.S.C. §119 to U.S. Provisional Patent Application No. 62/102,444 filed on Jan. 12, 2015, the entire contents of which are incorporated herein by reference.

### BACKGROUND

The present disclosure is described in the context of nozzle arrangements for agricultural sprayers that are capable of delivering variable flow rates and maintaining a controlled flow of fluid. More specifically, the present disclosure relates to nozzle assemblies with a dynamic nozzle orifice that establishes a substantially uniform flow response to alterations in an applied upstream fluid pressure.

Agricultural sprayers can be mounted to a motorized vehicle, such as a farm tractor. These sprayers typically include one or more tanks storing material to be applied to a farm field (e.g., an agricultural fluid including crop protection chemicals such as fertilizers, herbicides, insecticides, fungicides, and the like), a spraying boom/arm, a plurality of spray nozzles mounted along the boom (each having a spray tip), plumbing for carrying materials from the tank to the various nozzles, and at least one pump for motivating material from the tank, through the plumbing, and out the nozzles. The material is thus sprayed down onto the desired areas of a field. However, there can be significant variations in field fertility results over a single field. To account for these variations, one solution is to identify these different areas and then apply the preferred amount of material to each of these areas within a particular field.

Some nozzles offer fixed orifices that are capable of marginally varying the flow of material to be dispersed from the nozzle onto a field as the applied upstream pressure fluctuates. Fixed-orifice nozzles, however, can vary material flow rate only within a limited range. However, if output flow requirements change (e.g., due to changes in tractor/sprayer speed or required material application to a particular area of a field), fixed-orifice nozzles are not currently capable of delivering an effective variable flow rate. Operators must typically exchange the spray tips of each nozzle to achieve the desired flow. Stopping a spraying operation to change a spray tip can be a time-consuming task that hampers overall efficiency and economy.

Some nozzles purport to operate under a wider range of flow rates. However, these nozzles primarily rely upon use of an elastomeric material to achieve a non-uniform, environmentally-sensitive flow rate. The use of these elastomer-type materials is hampered by performance variability stemming from, for instance, manufacturing and material properties (e.g., elasticity) that can exhibit inconsistent flow response to an applied upstream pressure and an undesirable response to environmental influences, such as fluctuations in ambient operating temperature. The lack of uniformity and inconsistency of these elastomeric-based nozzles hamper the accurate application of materials during a spraying operation.

Therefore, there is a need for a variable flow nozzle that provides a substantially uniform flow response over a range of upstream pressures, while simultaneously being robust in view of considerable manufacturing and environmental factors.

### SUMMARY

Some embodiments of the invention provide a variable flow nozzle assembly capable of flowing a fluid within a range of flow rates in response to a variable upstream fluid pressure. The assembly comprises a spray tip that defines a chamber, and a flow port in fluid communication with the chamber and atmosphere. A pre-orifice defines a flow path in fluid communication with the chamber, and a metering portion along the flow path. A spool valve defines a spool rod portion, the spool rod portion being positioned within the metering portion of the pre-orifice and configured to be moveable in response to an applied upstream fluid pressure between a minimum flow position and a maximum flow position. A biasing mechanism is positioned within the spray tip and is configured to bias the spool valve toward the minimum flow position. An opening defined between the metering portion and the spool rod portion allowing for flow of the fluid through the flow path to be greater when the spool valve is in the maximum flow position than when the spool valve is in the minimum flow position.

Some embodiments of the invention provide a variable flow nozzle assembly capable of flowing an agricultural fluid within a range of flow rates in response to a variable upstream fluid pressure. The assembly comprises a spray tip that defines a chamber, and a flow port in fluid communication with the chamber and atmosphere. A pre-orifice defines a flow path in fluid communication with an upstream fluid source providing the agricultural fluid under pressure and the chamber, the pre-orifice further defines a metering portion along the flow path that is positioned between the upstream fluid source and the chamber. A spool valve is positioned within the metering portion of the pre-orifice and is configured to be moveable between an upstream minimum flow position, at which a space between the metering portion and the spool valve is at a minimum to reduce the throughput of the agricultural fluid through the flow path, and a downstream maximum flow position, at which the space is at a maximum to increase the throughput of the agricultural fluid through the flow path. A biasing mechanism is positioned within the spray tip and is configured to urge the spool valve toward the upstream minimum flow position.

Some embodiments of the invention provide a method of varying a downstream flow rate of a fluid through a variable flow nozzle assembly. The method comprises the steps of: providing a variable flow nozzle assembly in fluid communication with a pressurized upstream fluid supply, the variable flow nozzle assembly comprising a pre-orifice adapted to receive fluid under pressure and defining a flow path in which a spool valve is seated and biased toward a minimum flow position and moveable to a maximum flow position in response to an increase in upstream pressure of the fluid within the flow path; and increasing upstream pressure of the fluid within the flow path to urge the spool valve toward the maximum flow position by countering at least a portion of the bias toward the minimum flow position. An approximately four-fold increase in the upstream pressure results in an approximately greater than three-fold increase in a flow of the fluid through the variable flow nozzle assembly.

### BRIEF DESCRIPTION OF THE DRAWINGS

FIG. 1 is a top isometric view of a nozzle assembly according to one embodiment of the invention.

FIG. 2 is a bottom isometric view of the nozzle assembly shown in FIG. 1.

FIG. 3 is an exploded, isometric view of the nozzle assembly shown in FIG. 1.

FIG. 4 is a cross-sectional view of the nozzle assembly shown in FIG. 1 along line 4-4.

FIG. 5 is a top isometric view of a pre-orifice according to one embodiment of the invention.

FIG. 6 is a cross-sectional view of the pre-orifice shown in FIG. 5 along line 6-6.

FIG. 7 is top isometric view of a spool valve according to one embodiment of the invention.

FIG. 8 is a cross-sectional view of the spool valve shown in FIG. 7 along line 8-8.

FIG. 9 is a top isometric view of a retainer according to one embodiment of the invention.

FIG. 10 is a cross-sectional view of the retainer shown in FIG. 9 along line 10-10.

FIG. 11 is a top isometric view of a spray tip according to one embodiment of the invention.

FIG. 12 is a cross-sectional view of the spray tip shown in FIG. 11 along line 12-12.

FIG. 13 is a cross-sectional view of the nozzle assembly in a minimum flow position.

FIG. 14 is a cross-sectional view of the nozzle assembly in an intermediate flow position.

FIG. 15 is a cross-sectional view of the nozzle assembly in a maximum flow position.

FIG. 16 is a graph illustrating the pressure versus flow rate profiles for nozzle assemblies of different dimensions.

FIG. 17 is a cross-sectional view of a nozzle assembly according to another embodiment of the invention.

FIG. 18 is a top isometric view of a spool valve according to another embodiment of the invention.

FIG. 19 is a cross-sectional view of the spool valve shown in FIG. 18 along line 19-19.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

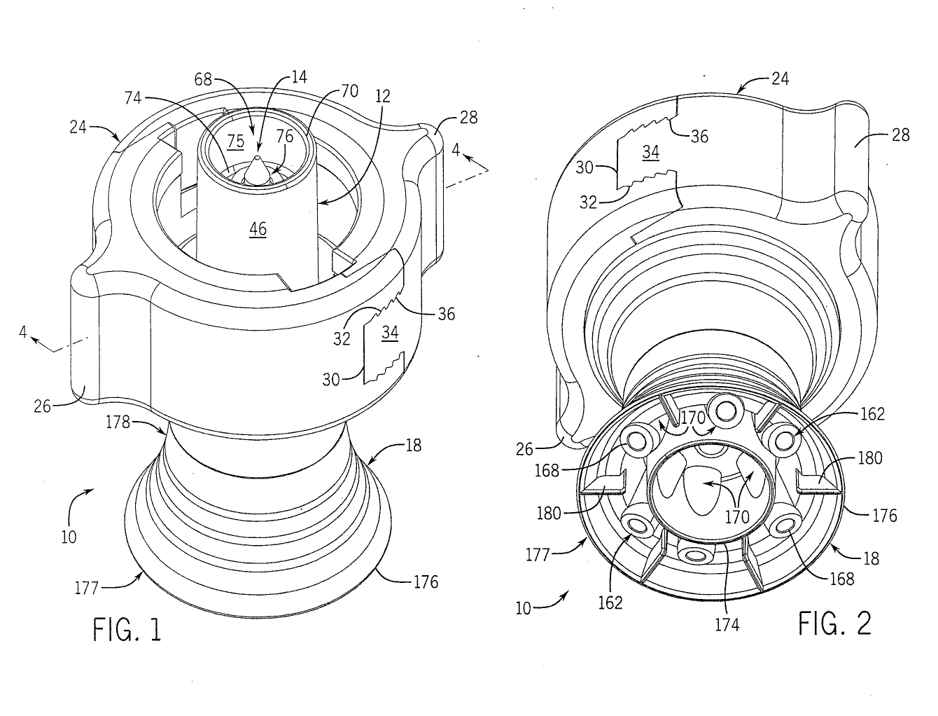

FIGS. 1 through 4 illustrate a nozzle assembly 10 according to one embodiment of the invention. The nozzle assembly 10 can include the combined arrangement of a pre-orifice 12, a spool valve 14, a retainer 16, a spray tip 18, a biasing mechanism 20, and a seal 22. While the various components are illustrated as physically distinct, one or more components may be integral, such as an integral formation of the retainer 16 and the spray tip 18. In addition, the components may be made from application-specific materials, such as plastics and metals, that are suitable for a particular application.

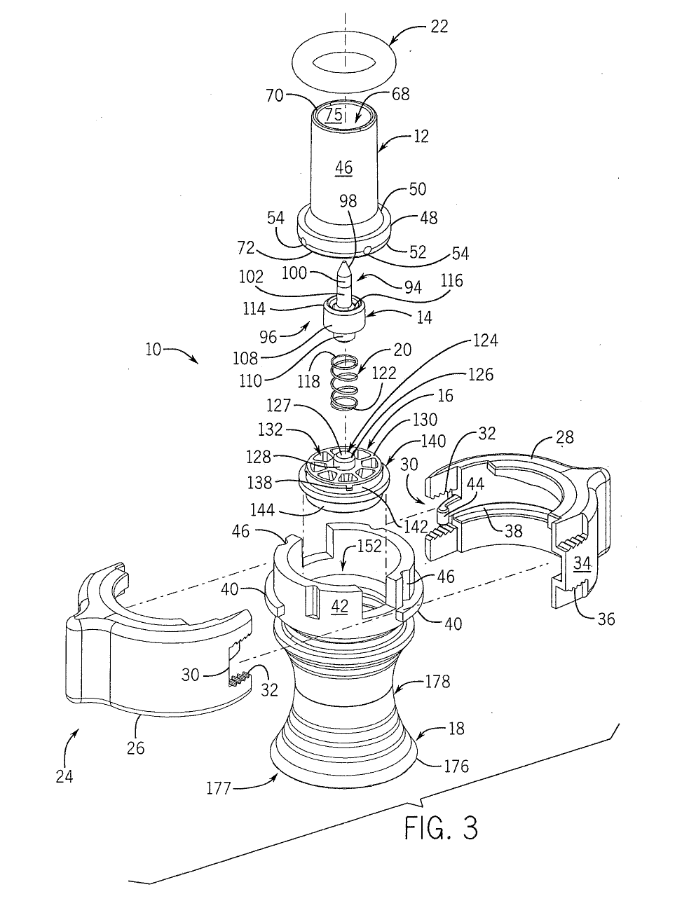

In one example, the nozzle assembly 10 includes a locking collar 24 comprised of two generally c-shaped portions 26, 28 selectively separable from each other (shown in FIG. 3). Each portion 26, 28 defines a jagged recess 30 having teeth 32 and a jagged tab 34 also having teeth 36. The opposite recesses 30 and tabs 34 are configured to engage with the mating structures on the opposite portion 26, 28 of the locking collar 24. Each portion 26, 28 further defines an arcuate groove 38 configured to receive a matching arcuate protrusion 40 that extends from an upstream exterior surface 42 of the spray tip 18. The engagement between the groove 38 and the protrusion 40 axially couples the locking collar 24 and the spray tip 18. In addition, each portion 26, 28 of the locking collar 24 includes a respective flexible tang 44 that is configured to seat with a respective axially-oriented groove 46 (shown in FIG. 3) formed in the upstream exterior surface 42 of the spray tip 18. The illustrative engagement between the locking collar 24 and the spray tip 18 is only one example construction available to couple the nozzle assembly 10 to an upstream pressurized fluid supply.

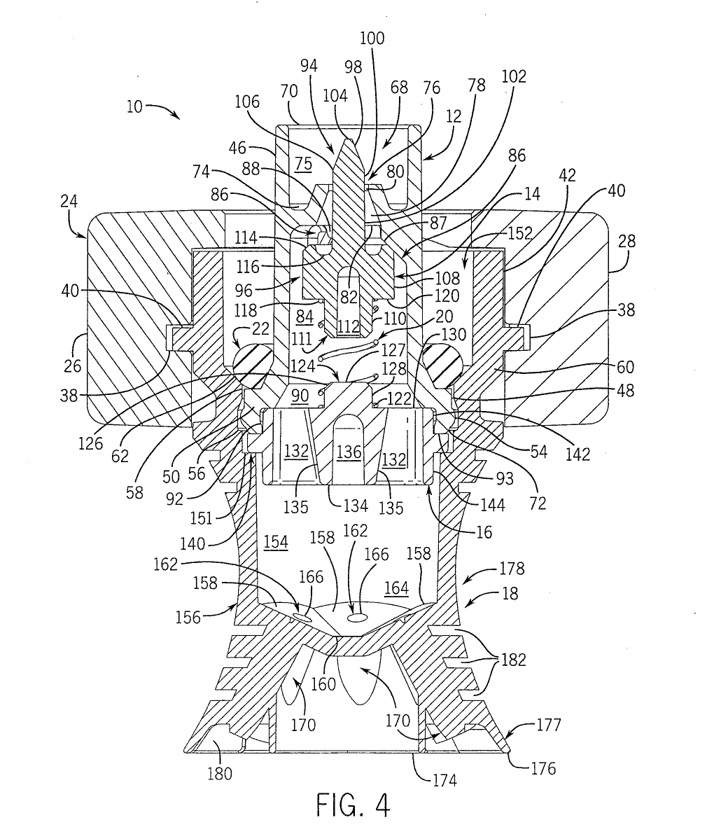

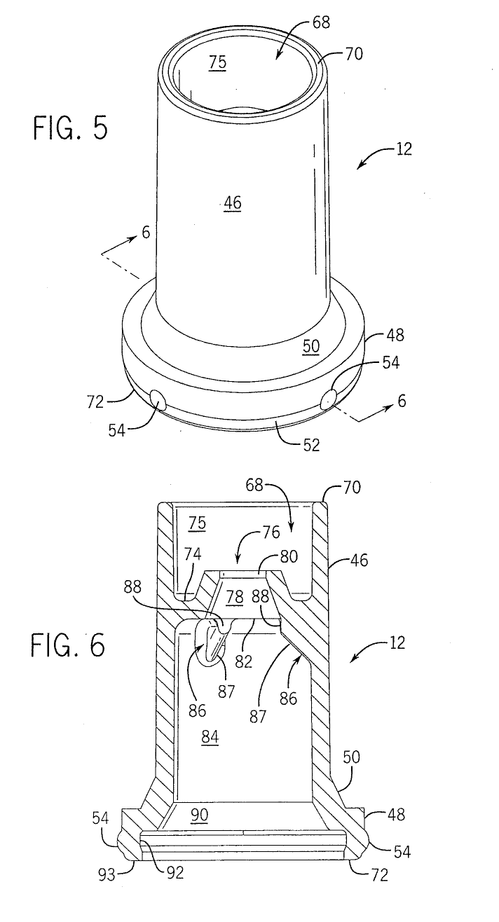

FIGS. 5 and 6 illustrate one embodiment of the pre-orifice 12 of the example nozzle assembly 10. The pre-orifice 12 defines a generally cylindrical upper body portion 46 and a lower annular portion 48 that are connected by a beveled intermediate portion 50. The lower annular portion 48 includes a chamfered lower surface 52 that is beveled toward a central axis of the pre-orifice 12. A series of circumferentially spaced, rounded projections 54 extend from the lower annular portion 48 and are sized to engage with a mating internal annular groove 56 formed in an interior surface 58 of the spray tip 18 (shown in FIGS. 4 and 12). The rounded projections 54 and the groove 56 cooperate to axially restrain the pre-orifice 12 relative to the spray tip 18. The intermediate portion 50 cooperates with a necked portion 60 of the spray tip 18 to form a seat 62 that receives the seal 22 (shown in FIG. 4). The seal 22 inhibits fluid from passing downstream of the seal 22 between the exterior of the pre-orifice 12 and the interior of the spray tip 18. The seal 22 may comprise an elastomeric o-ring seal. Other sealing arrangements and configurations can be employed to direct upstream fluid to the intended flow path through the nozzle assembly 10.

A fluid flow path 68 is generally defined between an upstream end 70 and a downstream end 72 of the pre-orifice 12. The upstream end 70 includes a circumferential interior groove 74 that aids in slowing down and diverting higher velocity fluid entering the pre-orifice 12. The upstream end 70 includes an interior wall 75 that slightly tapers inward toward the central axis of the pre-orifice 12 in a direction from upstream to downstream. A metering portion 76 is positioned between the upstream end 70 and the downstream end 72, and cooperates with the dynamic position of the spool valve 14 to define the dimensions and geometry of the fluid flow path 68 through the metering portion 76. The metering portion 76 defines a generally frustoconical interior surface 78 with a smaller upstream opening 80 and a larger downstream opening 82. In several examples, the upstream opening 80 can have a diameter ranging about 1.5-3.5 mm and the downstream opening 82 can have a diameter ranging about 5-6 mm over a respective axial distance ranging about 2-3.5 mm. Therefore, in these examples, a relative ratio of downstream and upstream area of frustoconical interior surface 78 is on the order of 2-4. The pre-orifice 12 includes a generally cylindrical interior surface 84 downstream of the metering portion 76. The interior surface 84 defines several circumferentially-spaced, triangular gussets 86 that extend inward from the interior surface 84 toward the central axis of the pre-orifice 12 (only two are illustrated in FIG. 6, one being shown in cross-section). Each gusset 86 defines a bearing surface 87 and an end surface 88 that are configured to engage and guide the spool valve 14 as the spool valve 14 axially translates relative to the pre-orifice 12.

The pre-orifice 12 defines a flared portion 90 near the downstream end 72 that transitions from the cylindrical interior surface 84 to a recessed annular seat 92 formed near the downstream end 72. As described below, the flared portion 90 is sized to direct fluid from the pre-orifice 12 through the structures defined by the retainer 16. The annular seat 92 is configured to receive a portion of the retainer 16. In addition, an annular downstream end face 93 of the pre-orifice 12 abuts a portion of the retainer 16 in the assembled nozzle assembly 10 (shown in FIG. 4).

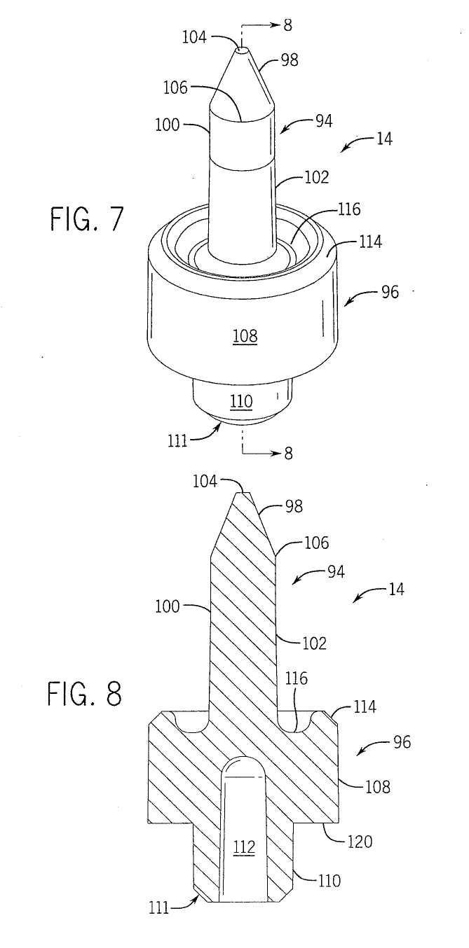

FIGS. 7 and 8 illustrate one embodiment of the spool valve 14 that includes an upstream spool rod portion 94 and a downstream spool body portion 96. The spool rod portion 94 is generally concentric with the spool body portion 96 and is configured to be movable within and relative to the metering portion 76 of the pre-orifice 12, thus influencing the flow of fluid through the metering portion 76 and out through the spray tip 18. The upstream spool rod portion 94 defines a generally conical metering tip 98, a cylindrical intermediate shank 100, and a flared base shank 102 that flares radially outward toward the spool body portion 96. The metering tip 98 defines an upstream tip face 104 and a downstream tip base 106. In several examples, the upstream tip face 104 can have a diameter ranging about 0.5-1 mm and the downstream tip base 106 can have a diameter ranging about 1-3 mm over a respective axial distance ranging about 2-4 mm. Therefore, in these examples, a relative ratio of downstream and upstream area of conical metering tip 98 is on the order of 3-36.

The downstream spool body portion 96 extends further radially outward than the upstream spool rod portion 94. The spool body portion 96 defines an upstream cylindrical portion 108 that transitions to a stepped downstream cylindrical portion 110. An internal cavity 112 extends along the central axis of the spool valve 14, through the downstream cylindrical portion 110, and partially into the upstream cylindrical portion 108. The upstream cylindrical portion 108 includes a chamfered exterior upper rim 114 and an annular recess 116 circumscribing the base shank 102 of the upstream spool rod portion 94. The annular recess 116 is provided to avoid or minimize turbulence in the cylindrical portion 154 of the spray tip 18, for example, by stopping or inhibiting higher velocity fluid from entering straight into the cylindrical portion 154 and by velocity loss due to recirculation formation in flow around the annual recess 116.

With additional reference to FIG. 4, the spool body portion 96 of the spool valve 14 is configured to receive and engage with an upstream end 118 of the example biasing mechanism 20. In particular, the upstream cylindrical portion 108 defines an axial end face 120 that abuts the upstream end 118 of the biasing mechanism 20, and the stepped downstream cylindrical portion 110 is sized to fit into the biasing mechanism 20 and defines a chamfered axial end 111. A downstream end 122 of the biasing mechanism 20 is configured to cooperate with the retainer 16, as described below, such that compression of the biasing mechanism 20 is related to the relative position of the spool valve 14 and the retainer 16. In one embodiment, this biasing mechanism 20 can be a coil spring or another type of biasing mechanism, such as a spring washer, elastomeric spring, and the like, with the spool valve 14, retainer 16, and any other components being adapted accordingly.

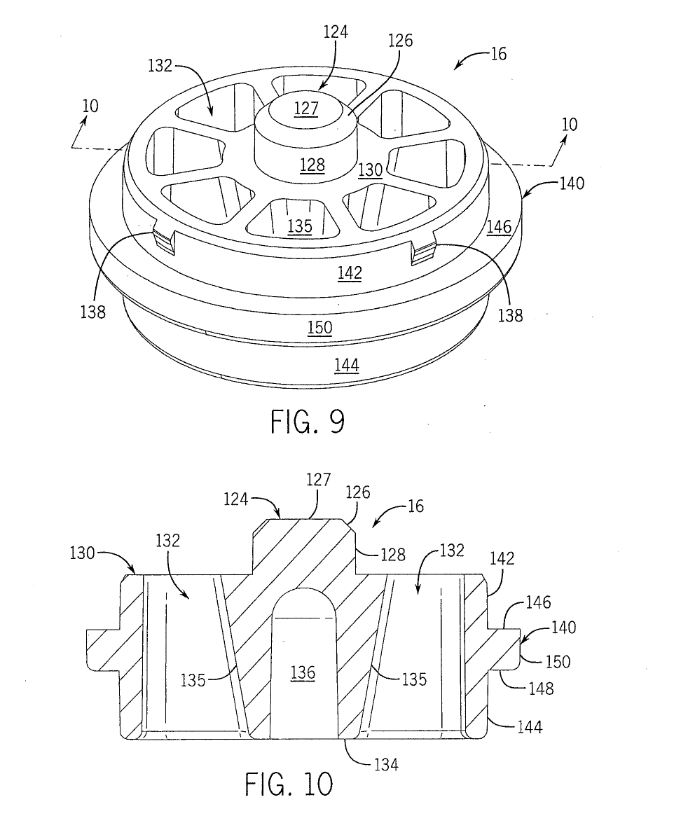

FIGS. 9 and 10 illustrate one embodiment of the retainer 16. The retainer 16 defines a cylindrical central protrusion 124 having a beveled rim 126 and an axial abutment surface 127. The central protrusion 124 is configured to cooperate with the downstream end 122 of the biasing mechanism 20, such that an exterior surface 128 of the central protrusion 124 is sized to fit into the biasing mechanism 20. The central protrusion 124 extends from an upstream axial face 130 of the retainer 16 that abuts the downstream end 122 of the biasing mechanism 20. The upstream axial face 130 further defines a series of circumferentially spaced flow channels 132 that extend from the upstream axial face 130, through the retainer 16, and to a downstream axial face 134. The flow channels 132 generally define trapezoidal-type cross-sections (as viewed in a plane that is orthogonal to a central axis of the retainer 16). The flow channels 132 expand inward along wall 135 toward the central axis of the retainer 16 moving in a downstream direction (shown in FIG. 10). The flow channels 132 influence and straighten the flow of fluid through the retainer 16. The downstream axial face 134 of the retainer 16 further includes a pocket 136 aligned with the central axis of the retainer 16. The pocket 136 is present to avoid an excessively thick area zone when the retainer 16 is a plastic molded part.

The retainer 16 further defines several circumferentially spaced ramps 138 that are configured to engage (e.g., in a snap-fit configuration) with the annular seat 92 of the pre-orifice 12 to couple the retainer 16 and the pre-orifice 12, thereby capturing the biasing mechanism 20 (shown in FIG. 4). An annular rim 140 of the retainer 16 protrudes radially outward between an upstream cylindrical surface 142 and a downstream cylindrical surface 144, which both can be slightly tapered inward toward the central axis of the retainer 16. The rim 140 includes an upstream axial face 146 and a downstream axial face 148 connected by a radial face 150. As shown in FIG. 4, the upstream axial face 146 of the retainer 16 abuts the annular downstream end face 94 of the pre-orifice 12 when the ramps 138 are engaged with the annular seat 92 of the pre-orifice 12. Further, the downstream axial face 148 of the rim 140 abuts an interior annular ledge 151 (defined by the spray tip 18) when the rounded projections 54 of the pre-orifice 12 engage with the groove 56 in the spray tip 18.

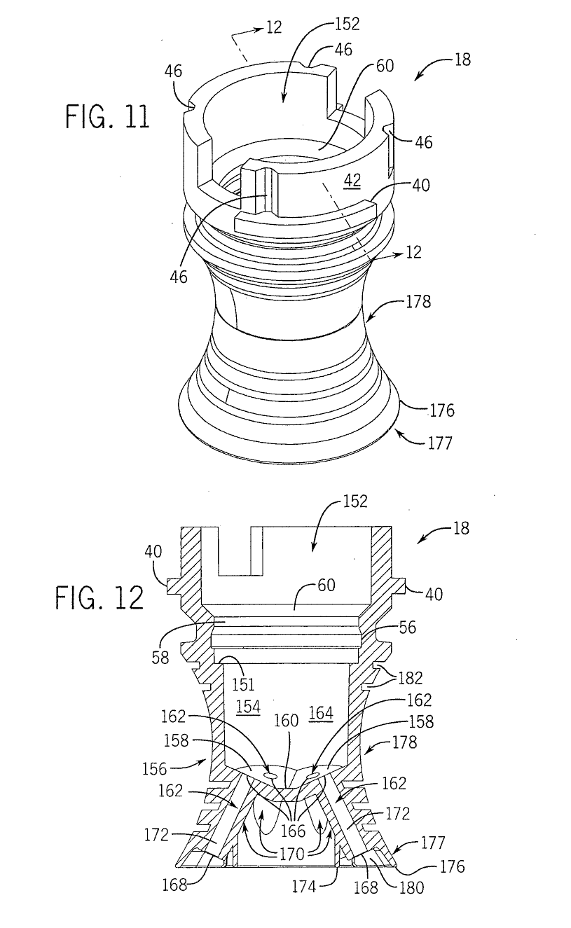

FIGS. 11 and 12 illustrate one embodiment of the spray tip 18, portions of which have been described above. The spray tip 18 includes a central chamber 152 into which the retainer 16, the biasing mechanism 20, the spool valve 14, the pre-orifice 12, and the seal 22 are arranged and housed when the nozzle assembly 10 is assembled (depicted in FIGS. 3 and 4). The chamber 152 defines a downstream generally cylindrical portion 154. A downstream end 156 of the cylindrical portion 154 includes a series of wedge-shaped surfaces 158 circumscribing a central, planar hub surface 160. Each of the wedge-shaped surfaces 158 defines a circular flow port 162 approximately midway between the hub surface 160 and a cylindrical wall 164 of the cylindrical portion 154. The flow ports 162 define an upstream inlet opening 166 in fluid communication with the chamber 152, and a downstream outlet opening 168 in fluid communication with atmosphere. The inlet opening 166 and the outlet opening 168 are connected by a tubular structure 170. The flow port 162 defines a generally uniform cylindrical inner surface 172 connecting the inlet opening 166 and the outlet opening 168. In several embodiments, the diameters of the inlet opening 166 and the outlet opening 168 range about 0.6-2 mm, and the length of the inner surface 172 connecting the inlet opening 166 and the outlet opening 168 ranges about 3-12 mm. The outlet opening 168 is positioned generally between an inner annular shield 174 that intersects the tubular structure 170 and an outer annular shield 176 circumscribing a downstream end 177 of the spray tip 18. The outer annular shield 176 is integral with an hourglass-shaped exterior surface 178 of the spray tip 18. Divider walls 180 are positioned between adjacent tubular structures 170 and extend radially inward from the outer annular shield 176. The exterior surface 178 of the spray tip 18 also includes a series of ringed recesses 182. The ringed recesses 182 can be included to avoid excessively thick areas when the components are plastic molded parts. While the example illustrates six flow ports 162 with two sets grouped closer together and two additional flow ports 162 between the two sets, any appropriate number or spacing of flow ports 162 may be used to achieve the desired flow response characteristics. In addition, the flow ports 162 may be skewed relative to a central axis of the spray tip 18, such that a central axis of a flow port is not oriented to intersect the central axis of the spray tip 18.

Alternative approaches can be used to attach and interconnect, for example, the pre-orifice 12, the retainer 16, and the spray tip 18. For instance, a press-fit or snap-fit arrangement can be implemented, with protrusions/ridges and recesses/grooves formed on one or more of the components to be coupled, whether on relative interior or exterior surfaces of the mating components.

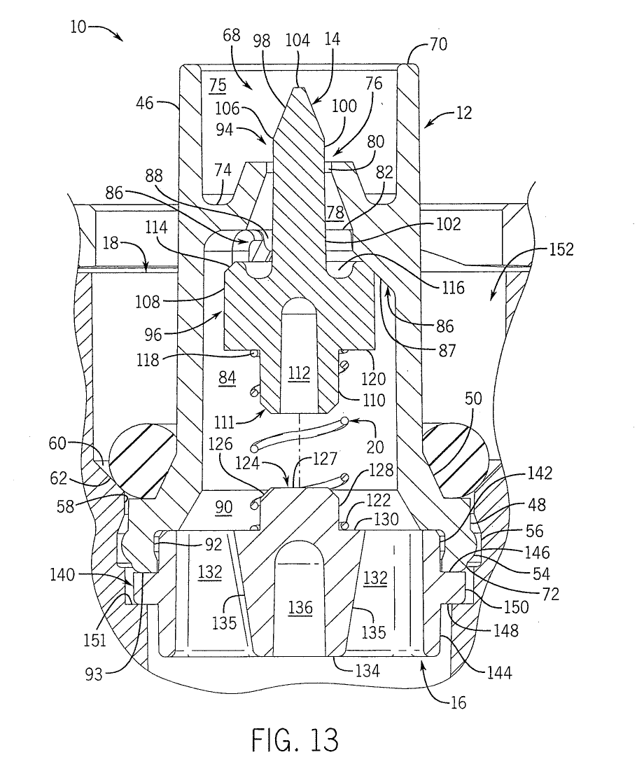

Operation of the nozzle assembly 10 is described in further view of FIGS. 13-16. The respective structures defined by the pre-orifice 12, the spool valve 14, the retainer 16, and the spray nozzle 18, the relative positioning between the spool valve 14 and the pre-orifice 12, and the dynamic interaction between the applied upstream pressure, the spool valve 14, and the biasing mechanism 20, all cooperate to produce the desired uniform flow characteristics of the overall nozzle assembly 10.

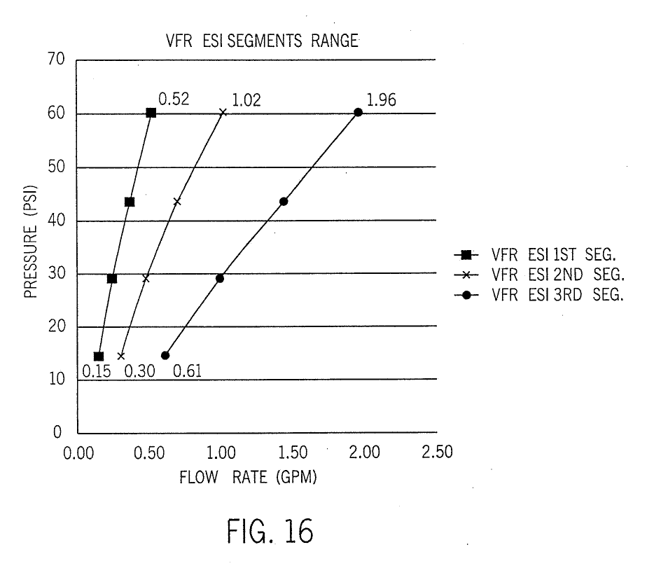

FIG. 13 illustrates the nozzle assembly 10 in the minimum flow position, whereat the spool valve 14 is urged upstream by the biasing mechanism 20 until the chamfered upper rim 114 of the downstream cylindrical portion 110 of the spool valve 14 abuts the bearing surfaces 87 of the gussets 86 formed in the pre-orifice 12. The minimum flow position shown in FIG. 13 can be representative of an upstream flow pressure of approximately 15 psi illustrated in the graph of FIG. 16, which includes pressure-flow rate curves for three example nozzle assemblies 10 of varying dimensions to cover a particular range of available flow rates for a single nozzle assembly 10. The biasing mechanism 20 (e.g., a spring) may be preloaded with sufficient force (e.g., such as by compression/displacement) to exert a counter force against the minimum operating pressure force acting on the spool valve 14. In one example, spring force is linearly proportional to the compression of the spring and the magnitude depends upon a specific spring rate/constant. In several examples, the spring rate is approximately ranged 0.10-1.20 N/mm.

As pressurized upstream fluid enters the nozzle assembly 10, the fluid engages and urges the spool valve 14 in a generally downstream direction. For example, the fluid pressure acts upon the various surfaces of the spool valve 14, such as the metering tip 98 and the downstream spool body portion 96 (including the annular recess 116 of the upstream cylindrical portion 108), with a resulting net downstream force being applied to the spool valve 14. The physical envelope through which the fluid can pass at a particular pressure is generally governed by the gap or spacing between the metering portion 76 of the pre-orifice 12 and the spool rod portion 94 of the spool valve 14. The net downstream axial fluid pressure exerted on the spool valve 14 by the fluid is countered by the opposite axial spring force provided by the biasing mechanism 20. Altering the size, geometry, relative positioning, spring constant, and the like can alter the upstream pressure-downstream flow rate profile of a particular nozzle assembly 10. In one form, the nozzle assembly 10 is configured to establish a relatively uniform pressure-flow rate correlation, similar to the profiles illustrated in FIG. 16. The relative movement between the pre-orifice 12 and the spool valve 14 allows for a uniform, dynamic flow rate response to a change in the applied upstream fluid pressure to the nozzle assembly 10. Thus, a specific nozzle assembly 10 may accommodate a range of fluid pressures that establish a corresponding range of flow rates from the nozzle tip 18.

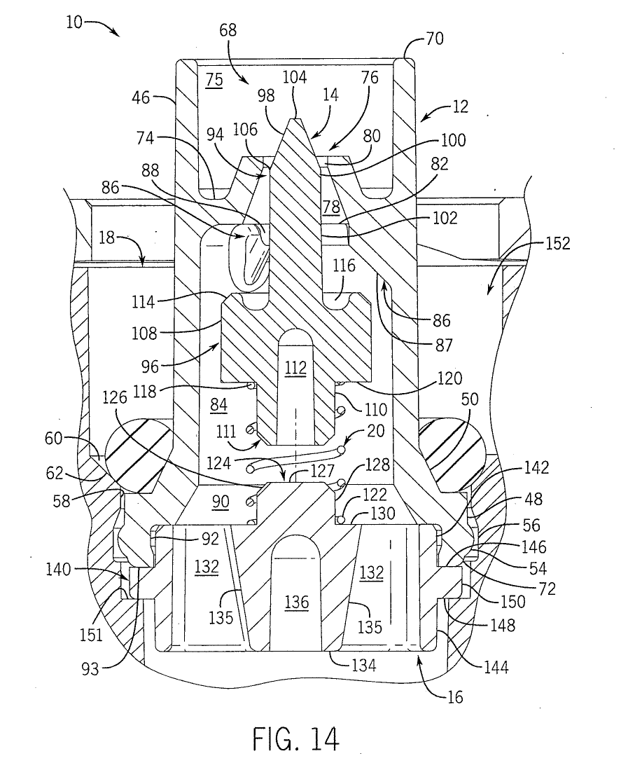

FIG. 14 illustrates the nozzle assembly 10 in an intermediate flow position, whereat the spool valve 14 is urged downstream from the minimum flow position (shown in FIG. 13) by fluid pressure sufficient to partially compress the biasing mechanism 20. The intermediate flow position shown in FIG. 14 can be representative of an upstream flow pressure of approximately greater than 15 psi and approximately less than 60 psi as illustrated in the graph of FIG. 16, which includes pressure-flow rate curves for the three example nozzle assemblies 10 of varying dimensions that cover an engineered range of available flow rates.

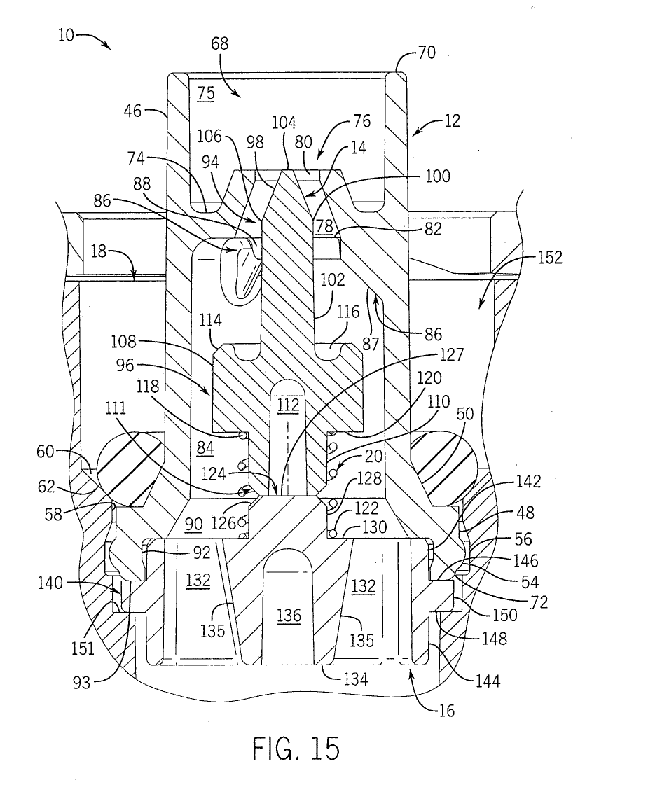

FIG. 15 illustrates the nozzle assembly 10 in the maximum flow position, whereat the spool valve 14 is urged downstream, compressing the biasing mechanism 20 until the axial end 111 of the spool valve 14 engages the axial abutment surface 127 of the retainer 16. The maximum flow position shown in FIG. 15 can be representative of an upstream flow pressure of approximately 60 psi illustrated in the graph of FIG. 16, which includes pressure-flow rate curves for three example nozzle assemblies 10 of varying dimensions to cover a range of available flow rates. In the maximum flow position, the physical envelope through which the fluid can pass is maximized, that is, the gap or spacing between the metering portion 76 of the pre-orifice 12 and the spool rod portion 94 of the spool valve 14 is at its largest. The upstream pressure is at least sufficient to compress the biasing mechanism 20 resulting in physical contact and interference between the spool valve 14 the retainer 16.

In moving from the minimum flow position to the maximum flow position, fluid enters the nozzle assembly 10 through the pre-orifice 12. This fluid typically enters at a high velocity and the circumferential groove 74 helps to reduce the velocity and divert the incoming fluid. As additional fluid continues to flow into the pre-orifice 12, pressure continues to build against the spool valve 14. The spool valve 14 responds to the upstream fluid pressure acting upon it by applying a generally axial force against the biasing mechanism 20, which is also engaged with the retainer 16. As the biasing mechanism 20 compresses, the spool valve 14 opens further and continues to axially displace against the force of the biasing member 20. This relative movement between the pre-orifice 12 and the spool valve 14 allows fluid to enter and flow through the opening between the upstream spool rod portion 94 of the spool valve 14 and the metering portion 76 of the pre-orifice 12. As the spool valve 14 continues to displace axially, this movement increases the opening and thus influences the flow rate of the fluid. This ability to change the size of the opening for the fluid flow path allows for variable flow rates in response to variations in upstream pressure. Varying the fluid flow rate in response to variations in pressure allows a steady, uniform, and controlled flow rate with stable fluid jet streams (with little or no fragmentation) to be reasonably maintained. Further, as fluid passes through the flow channels 132 of the retainer 16, the fluid flow may become increasingly laminar and straight, helping to maintain an output flow that is stable and has reduced or little atomization as pressurized fluid leaves the outlet openings 168 of the respective flow ports 162.

As illustrated in the chart of FIG. 16, nozzle assemblies 10 constructed in accordance with this disclosure establish that an approximately four-times increase in pounds per square inch of upstream pressure results in approximately a greater than three-times increase in gallons per minute flow rate.

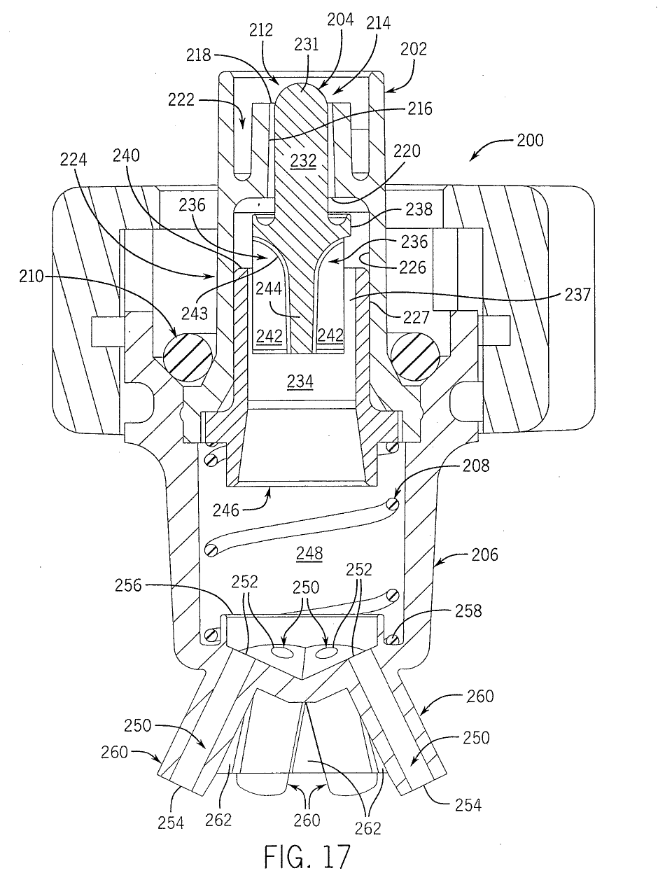

FIG. 17 illustrates a nozzle assembly 200 according to another embodiment of the invention. The nozzle assembly 200 can include the combined arrangement of a pre-orifice 202, a spool valve 204, a spray tip 206, a biasing mechanism 208, and a seal 210. The basic components and operation are similar to the nozzle assembly 10 illustrated in connection with FIG. 4; therefore, only the relevant differences will be discussed in detail, with other distinctions being evident from the illustrative figures.

The pre-orifice 202 defines a fluid flow path 212 with a metering portion 214 positioned along the flow path 212. An interior surface 216 of the metering portion 214 is generally frustoconical defining a smaller upstream opening 218 and a larger downstream opening 220. The relative axial length of the metering portion 214 is generally greater than the configuration of the metering portion 76 of the nozzle assembly 10. Moreover, a circumferential groove 222 is formed in the pre-orifice 202 with a greater relative axial length as compared to the groove 74 of the nozzle assembly 10. In addition, a downstream cylindrical portion 224 of the pre-orifice 202 provides a bearing surface 226 against which an exterior surface 227 of the spool valve 204 can slide during operation of the nozzle assembly 200.

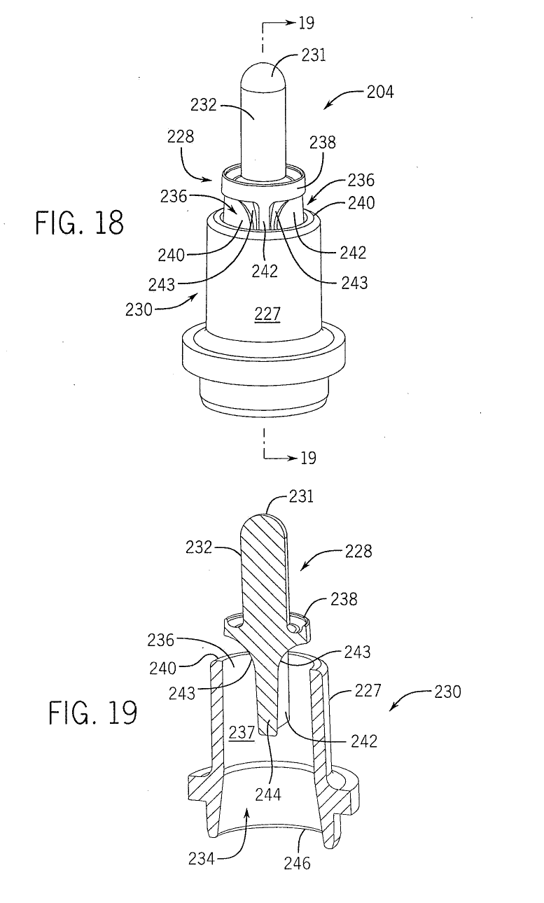

With additional reference to FIGS. 18 and 19, the spool valve 204 includes an upstream spool rod portion 228 and a downstream spool body portion 230. The spool rod portion 228 includes a spherical tip 231 and a generally cylindrical shaft 232. The tip 231 and the shaft 232 are configured to be moveable within the metering portion 214 of the pre-orifice 202 during operation of the nozzle assembly 200. As the spool valve 204 moves axially downstream in response to an increasing upstream fluid pressure (and against the biasing force of the biasing mechanism 208), a greater physical envelope is exposed between the interior surface 216 of the metering portion 214 and the spool rod portion 228. The spool body portion 230 defines an internal flow passage 234 through which fluid can enter through openings 236. The openings 236 are generally defined between an annular rim 238, an upstream end 240 of the spool body portion 230, and interior fins 242 (only one of which is illustrated in FIG. 19). The three example fins 242 are generally circumferentially spaced and define arcuate upstream surfaces 243 near the openings 236. The fluid enters the openings 236 and is directed downstream along an interior surface 237 of the spool body portion 230, the interior fins 242, and a central vane 244 toward a downstream opening 246 of the spool valve 204, whereat the fluid enters a chamber 248 of the spray tip 206. The configurations of the openings 236 and the fins 242 can also influence the characteristics of the fluid flow (e.g., becoming more laminar and straight as the fluid passes along the fins 242, helping to maintain an output flow that is stable and has minimal, if any, atomization) and the uniform flow rate of pressurized fluid through the spool valve 204 (e.g., having stable fluid jets streams with reduced, or no, fragmentation).

Fluid in the chamber 248 of the spray tip 206 can then flow to atmosphere through flow ports 250. The flow ports 250 include inlet openings 252 and outlet openings 254. The inlet openings 254 are positioned near a ridge 256 configured to locate a downstream end 258 of the biasing mechanism 208. Each flow port 250 is generally defined by a tubular structure 260 and a series of webs 262 interconnect adjacent tubular structures 260.

Similar to the operation of the nozzle assembly 10, the nozzle assembly 200 can provide a range of fluid flow rates in response to a range of upstream fluid pressures. As pressurized fluid enters the pre-orifice 202, the fluid pressure acts upon and urges the spool valve 204 downstream to counteract at least a portion of the axial biasing force provided by the biasing mechanism 208.

It will be appreciated by those skilled in the art that while the invention has been described above in connection with particular embodiments and examples, the invention is not necessarily so limited, and that numerous other embodiments, examples, uses, modifications, and departures from the embodiments, examples, and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A variable flow nozzle assembly capable of flowing a fluid within a range of flow rates in response to a variable upstream fluid pressure, the assembly comprising:
a spray tip defining a chamber, and a flow port in fluid communication with the chamber and atmosphere;
a pre-orifice defining a flow path in fluid communication with the chamber, and a metering portion along the flow path;
a spool valve defining a spool rod portion, the spool rod portion being positioned within the metering portion of the pre-orifice and configured to be moveable in response to an applied upstream fluid pressure between a minimum flow position and a maximum flow position; and
a biasing mechanism positioned within the spray tip and configured to bias the spool valve toward the minimum flow position;
wherein an opening defined between the metering portion and the spool rod portion allowing for flow of the fluid through the flow path to be greater when the spool valve is in the maximum flow position than when the spool valve is in the minimum flow position.

2. The assembly of claim 1, wherein the metering portion includes a frustoconical surface that defines at least a portion of the flow path.

3. The assembly of claim 2, wherein the frustoconical surface includes a smaller upstream opening and a larger downstream opening.

4. The assembly of claim 3, wherein the pre-orifice defines a circumferential groove circumscribing the smaller upstream opening.

5. The assembly of claim 1, wherein the spool valve defines a spool body portion that is concentric with the spool rod portion and extends radially outward beyond the spool rod portion.

6. The assembly of claim 5, wherein the spool body portion defines an annular recess circumscribing spool rod portion.

7. The assembly of claim 5, wherein the spool rod portion defines a conical tip, a cylindrical intermediate shank, and a flared lower shank.

8. The assembly of claim 1 further comprising a retainer positioned within the chamber downstream of the pre-orifice defining multiple flow channels through which the fluid can flow.

9. The assembly of claim 8, wherein the multiple flow channels extend from an upstream face of the retainer to a downstream face of the retainer and expand inward toward a central axis of the retainer.

10. The assembly of claim 1, wherein the metering portion defines a cross-sectional area perpendicular to a direction of aggregate fluid flow that varies along the direction.

11. A variable flow nozzle assembly capable of flowing an agricultural fluid within a range of flow rates in response to a variable upstream fluid pressure, the assembly comprising:
a spray tip defining a chamber, and a flow port in fluid communication with the chamber and atmosphere;
a pre-orifice defining a flow path in fluid communication with an upstream fluid source providing the agricultural fluid under pressure and the chamber, the pre-orifice further defining a metering portion along the flow path positioned between the upstream fluid source and the chamber;
a spool valve being positioned within the metering portion of the pre-orifice and configured to be moveable between an upstream minimum flow position, at which a space between the metering portion and the spool valve is at a minimum to reduce the throughput of the agricultural fluid through the flow path, and a downstream maximum flow position, at which the space is at a maximum to increase the throughput of the agricultural fluid through the flow path; and
a biasing mechanism positioned within the spray tip and configured to urge the spool valve toward the upstream minimum flow position.

12. The assembly of claim 11, wherein the space is defined between an interior surface of the metering portion and an exterior surface of the spool valve.

13. The assembly of claim 11, wherein the pre-orifice defines a circumferential groove surrounding the metering portion.

14. The assembly of claim 11, wherein the spool valve defines a spool rod portion and a spool body portion, the spool rod portion being sized to at least partially fit within the metering portion when the spool valve is in both the minimum flow position and the maximum flow position.

15. The assembly of claim 11, wherein an interior surface of the pre-orifice is configured to engage the spool valve to restrain non-axial movement of the spool valve.

16. The assembly of claim 11 further comprising a retainer positioned within the chamber downstream of the pre-orifice, the retainer defining multiple flow channels extending between an upstream face of the retainer and a downstream face of the retainer, wherein the multiple flow channels are generally trapezoidal as viewed in a direction parallel to a central axis of the retainer, and wherein the multiple flow channels expand inward toward the central axis in a direction from the upstream face to the downstream face.

17. The assembly of claim 11, wherein the metering portion defines an internal frustoconical surface having a smaller upstream opening and a larger downstream opening.

18. A method of varying a downstream flow rate of a fluid through a variable flow nozzle assembly, comprising the steps of:
providing a variable flow nozzle assembly in fluid communication with a pressurized upstream fluid supply, the variable flow nozzle assembly comprising a pre-orifice adapted to receive fluid under pressure and defining a flow path in which a spool valve is seated and biased toward a minimum flow position and moveable to a maximum flow position in response to an increase in upstream pressure of the fluid within the flow path; and
increasing upstream pressure of the fluid within the flow path to urge the spool valve toward the maximum flow position by countering at least a portion of the bias toward the minimum flow position;
wherein an approximately four-fold increase in the upstream pressure results in an approximately greater than three-fold increase in a flow of the fluid through the variable flow nozzle assembly.

19. The method of claim 18, wherein a uniform increase in the upstream pressure results in a uniform increase in the flow of the fluid through the variable flow nozzle assembly.
